(19) United States
(12) Patent Application Publication
(10) Pub. No.: US 2025/0156037 A1
(43) Pub. Date: May 15, 2025

(54) SWITCHING BETWEEN WEB CONTENT IN A HOSTED BROWSER TAB AND APPLICATION CONTENT

(71) Applicant: GOOGLE LLC, Mountain View, CA (US)

(72) Inventors: Victor Steven Gallet, Mill Valley, CA (US); Lan Julia Liang, Berkeley, CA (US); Aina Rubies Espinalt, San Francisco, CA (US); Zachary Aaron Katz, San Francisco, CA (US); Fahreddin Sinan Sahin, Sunnyvale, CA (US); Kevin Grosu, Redmond, WA (US); Theresa Marie Sullivan, Los Gatos, CA (US); Shaili Ajay Shah, San Jose, CA (US)

(21) Appl. No.: 18/506,685

(22) Filed: Nov. 10, 2023

(51) Int. Cl. G06F 3/0483; G06F 3/0482; G06F 40/134

(52) U.S. Cl. CPC G06F 3/0483; G06F 3/0482; G06F 40/134

(57) ABSTRACT

According to an aspect, a method includes, in response to selection, in a host application, of a link to web content, initiating display of a hosted browser tab with the web content, and in response to detecting an instruction to minimize the hosted browser tab, storing the hosted browser tab with the web content in a memory device, and initiating display of a floating window instead of the hosted browser tab, the floating window including information about the hosted browser tab.

### BACKGROUND

A hosted browser tab may be displayed when a user selects a link to web content from a non-browser application, where the hosted browser tab displays the web content. In some conventional approaches, a user can view and interact with the web content in the hosted browser tab, but, when returning to the underlying non-browser application (e.g., the user selects a back navigation control), the hosted browser tab is terminated, which causes a page state of the web content to be discarded.

### SUMMARY

This disclosure relates to a system that enables switching from web content in a hosted browser tab to application content of a host application in a manner that preserves a page state of the web content. For example, a host application (e.g., a non-browser application) may display application content with a link to web content. In response to a selection of the link to the web content from the host application, the system generates and displays a hosted browser tab with the web content, the hosted browser tab being associated with the host application. In some examples, a hosted browser tab is customized according to one or more customized attributes defined by the host application. In response to an instruction to minimize the hosted browser tab (e.g., a user-initiated action), the system stores the hosted browser tab (including a page state of the web content, and, in some examples, a navigation stack of web pages navigated by the user from the host browser tab), hides the hosted browser tab, and initiates display of a floating window with information about the hosted browser tab, thereby allowing the user to interact with the host application and other applications (e.g., opened or unopened apps) on the user device. In response to an instruction to restore the hosted browser tab (e.g., the user selects the floating window), the system retrieves the page state and redisplays the hosted browser tab using the page state.

In some aspects, the techniques described herein relate to a non-transitory computer-readable medium storing executable instructions that when executed by at least one processor cause the at least one processor to execute operations, the operations including: in response to selection, in a host application, of a link to web content, initiating display of a hosted browser tab with the web content; and in response to detecting an instruction to minimize the hosted browser tab: storing the hosted browser tab with the web content in a memory device; and initiating display of a floating window instead of the hosted browser tab, the floating window including information about the hosted browser tab.

In some aspects, the techniques described herein relate to an apparatus including: at least one processor; and a non-transitory computer-readable medium storing executable instructions that cause the at least one processor to execute: in response to selection, in a host application, of a link to web content, initiate display of a hosted browser tab according to at least one customized attribute, the hosted browser tab including the web content; and in response to detection of an instruction to minimize the hosted browser tab: store the hosted browser tab with the web content in a memory device; and initiate display of a floating window instead of the hosted browser tab, the floating window including information about the hosted browser tab.

In some aspects, the techniques described herein relate to a method including: in response to selection, in a host application, of a link to web content, initiating display of a hosted browser tab with the web content; and in response to detecting an instruction to minimize the hosted browser tab: storing the hosted browser tab with the web content in a memory device; and initiating display of a floating window instead of the hosted browser tab, the floating window including information about the hosted browser tab.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system for switching from web content in a hosted browser tab to application content of a host application according to an aspect.

FIG. 1B illustrates examples of customized attributes for a hosted browser tab according to an aspect.

FIG. 1C illustrates an example of a hosted browser tab according to an aspect.

FIG. 1D illustrates a detailed version of the system according to an aspect.

FIG. 2 illustrates a system for switching from web content in a hosted browser tab to application content of a host application according to another aspect.

FIGS. 3A to 3E illustrate various user interfaces for switching between application content and web content according to various aspects.

FIG. 4 illustrates a flowchart depicting example operations for switching between application content and web content.

### DETAILED DESCRIPTION

This disclosure relates to a system that enables switching from web content in a hosted browser tab to application content in a hosted application in a manner that preserves a page state of the web content and/or a navigation stack of web content opened in that browser session. For example, the system provides a technical solution for preserving the page state of the web content when navigating between a host application and web content provided by a hosted browser tab. In some conventional approaches, a user may enter data into one or more data fields of web content, but when an instruction to navigate back to the host application is detected (e.g., user selects the back button), the hosted browser tab is terminated, which causes any user provided information on the web content to be discarded. In some examples, switching from the hosted browser tab to the application causes the navigation stack to be discarded. Further, in some conventional approaches, a user is not able to return to the hosted application unless the hosted browser tab is terminated, which loses the page state of the web content. For example, switching from a hosted browser tab to the hosted application may cause a current page state of the web content to be discarded.

However, according to the techniques discussed herein, when the hosted browser tab is minimized, the user is able to view the underlying content in the host application. When minimized, the page state of the web content is maintained by storing the hosted browser tab, including a page state that includes any user-provided information, in a memory device. In some examples, the memory device also stores a list of web pages visited by the user from the hosted browser tab, which may be referred to as a navigation stack. Then, when the hosted browser tab is restored (e.g., maximized), the browser application retrieves and displays the hosted browser tab with a page state that corresponds to the page state when the hosted browser tab was minimized so that the user can continue to complete any remaining data fields or selections. In some examples, since the navigation stack is stored in the memory device, the user may use the navigation controls (e.g., back and/or forward) to navigate to web pages in the navigation stack. The technical benefits may include the reduction of computer resources (e.g., memory, CPU) that otherwise would be used to re-launch hosted browser tabs that have been terminated when users navigate back to their host applications and reduction of user interactions with the computing device to re-enter the user-provided information lost when the browser tab is terminated.

The system enables a user to minimize a hosted browser tab into a floating window, thereby allowing the user to interact with the host application and other applications opened on the user device. For example, a user can minimize the hosted browser tab, e.g., via a swipe down gesture (e.g., drag tab's toolbar) and/or selection of a dedicated control, which initiates a display of a floating window with information about the hosted browser tab. Once minimized, the web content is hidden, and the hosted browser tab is stored in a memory device, thereby preserving a page state of the web content. A page state of web content may refer to a current state of the elements on the web content, which may include values of input fields, the states of UI elements (e.g., buttons, checkboxes), and the visibility of the elements on the web page. The floating window may remain in the foreground while the user can interact with the host application and other applications on the user device. Further, the hosted browser tab can be restored (e.g., maximized) by selecting the floating window (and/or, in some examples, tapping on the expand button), which causes the hosted browser tab with the web content to be re-displayed on the user device. In other words, the system enables the user to minimize a hosted browser tab, navigate back to the host application, then restore the hosted browser tab to find the web content in the same state when the user minimized it.

In some examples, the system may allow multiple hosted browser tabs to be minimized, stored, and later retrieved. In some examples, although the minimization of multiple tabs may impact the device's overall memory usage, the system may provide a technical solution that limits the number of active minimized custom tabs and/or causes an active minimized custom tab to terminate after a threshold period of time (e.g., terminates after a threshold period of time).

In some examples, the floating window is a feature of an operating system of the computing device. In some examples, the floating window is a picture-in-picture window. In some examples, the system may provide a technical solution that enables the browser application to communicate with the operating system (and the host application) to create, display, and interact with a floating window. In some examples, the browser application transmits a request to an operating system to generate the floating window, where the request includes the information about the hosted browser tab.

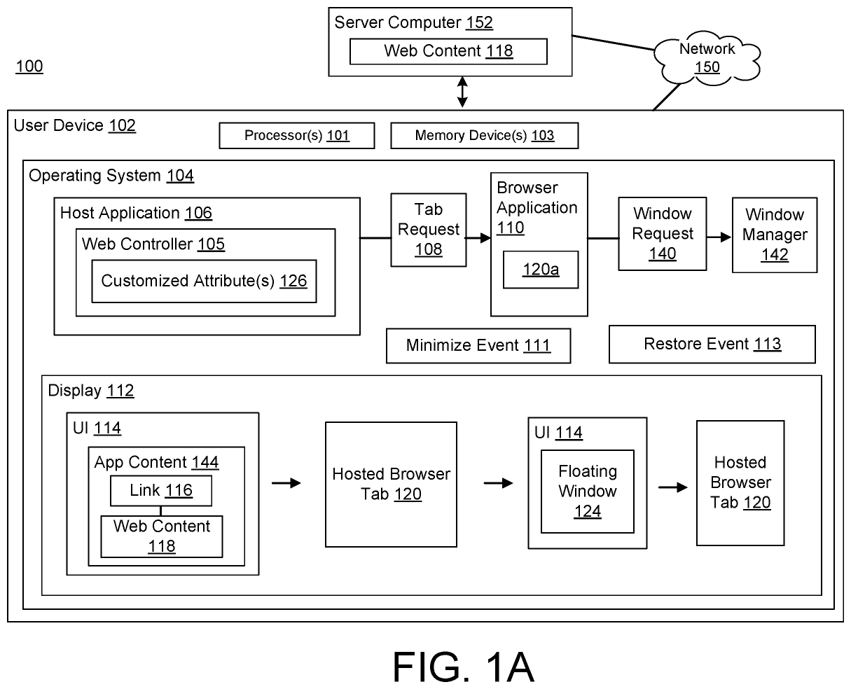

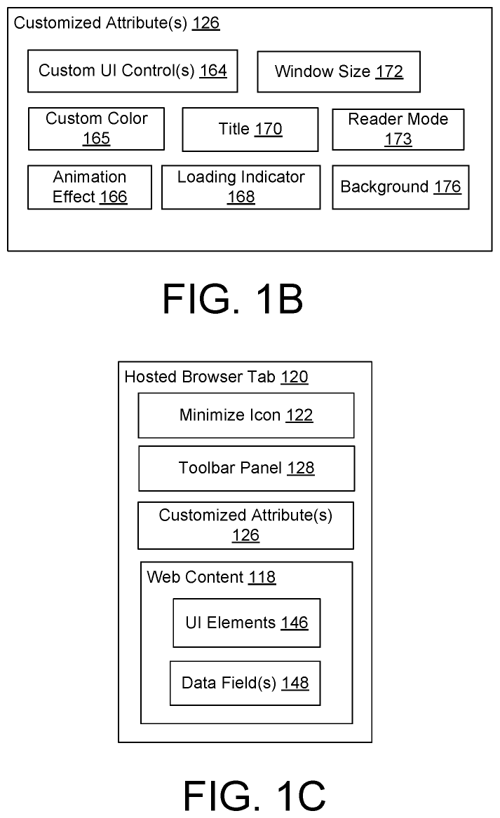

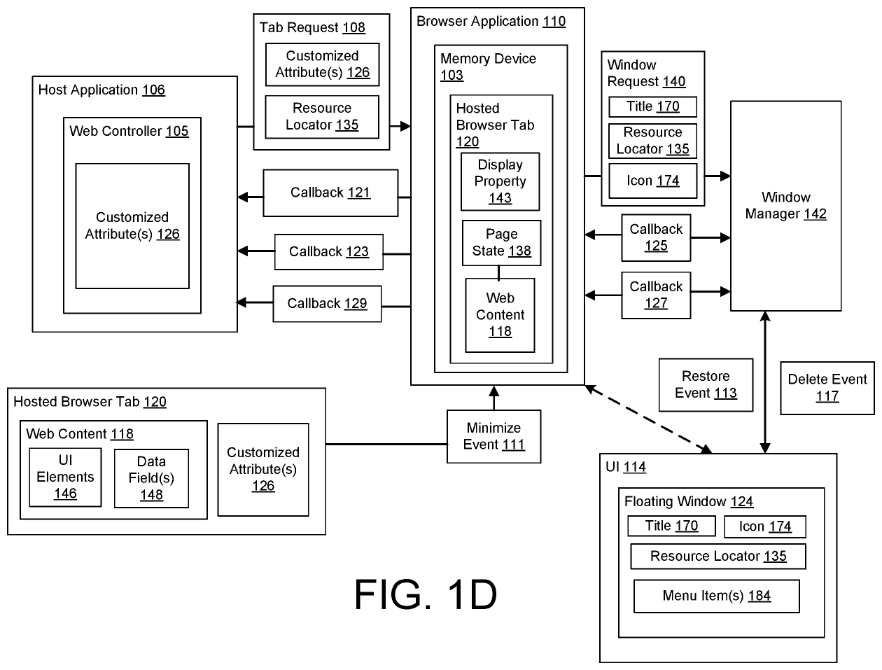

FIGS. 1A to 1D illustrate a system 100 that enables switching between application content 144 and web content 118 in a manner that preserves a page state 138 of the web content 118 rendered in a hosted browser tab 120.

The system 100 provides a technical solution for preserving the page state 138 of the web content 118 when navigating between a host application 106 and web content 118 provided by a hosted browser tab 120. When an instruction to minimize a hosted browser tab 120 is detected, the system 100 may store the hosted browser tab 120 (e.g., including the page state 138 and/or a navigation stack 145) in a memory device 103, hide the hosted browser tab 120, and initiate display of a floating window 124. The floating window 134 may persist across application boundaries, which can enable users to interact with any surface (e.g., open, or unopened apps) on a user device 102 while providing a mechanism to restore the hosted browser tab 120.

In some conventional approaches, a user may enter data into one or more data fields 148 of web content 118, but when an instruction to navigate to the host application 106 is detected (e.g., user selects the back button), the hosted browser tab 120 is terminated, which causes any user provided information on the web content 118 to be discarded. However, according to the techniques discussed herein, when the hosted browser tab 120 is minimized to enable the user to view application content 144 in the host application 106 (or another applications), the page state 138 of the web content 118 is maintained by storing the hosted browser tab 120, including any user-provided information, in a memory device 103.

In addition, the memory device 103 may also store a navigation stack 145 of web pages (previously visited by the user) using the hosted browser tab 120. Then, when the hosted browser tab 120 is restored (e.g., maximized), the browser application 110 retrieves and displays the hosted browser tab 120 in a page state 138 that corresponds to the page state 138 when the hosted browser tab 120 was minimized so that the user can continue to complete any remaining data fields or selections. In addition, since the navigation stack 145 of the hosted browser tab 120 is stored in the memory device 103, the restored hosted browser tab 120 may enable a user to revisit prior web pages, which were viewed by the user before the hosted browser tab 120 was minimized. The navigation stack 145 may include information (e.g., resource locator(s)) about previous web content displayed in the hosted browser tab 120. The navigation stack 145 may be one or more web pages previously displayed in the hosted browser tab 120. The technical benefits may include the reduction of computer resources (e.g., memory, CPU) that otherwise would be used to re-launch hosted browser tabs 120 that have been terminated when users navigate back to their host applications 106.

A hosted browser tab 120 may be a graphical user interface that displays web content 118 selected from a host application 106. A hosted browser tab 120 may be referred to as a browser window, a window that displays web content, a web interface, or a web window. A hosted browser tab 120 may include one or more UI elements associated with the web content 118 such as an address bar (e.g., displaying a resource locator 135), a navigation control (e.g., back and/or forward navigation controls), as well as other features such as translating feature that can translate a language of the web content 118 into a different language, a sharing feature that can share the web content 118 with other users, and/or a bookmarking feature that can bookmark the web content 118 for future retrieval, etc.

In some examples, the hosted browser tab 120 is a web window customized by a host application 106. In some examples, the hosted browser tab 120 is referred to as a custom browser tab (or custom web window or custom web interface). A custom browser tab is a hosted browser tab 120 with one or more customized attributes 126 defined by a host application 106. In some examples, a custom browser tab is displayed when a link 116 to web content 118 is selected in the host application 106.

A hosted browser tab 120 may be terminated (e.g., deleted) when an instruction to navigate back to the host application 106 is detected (e.g., the user selects a back navigation control). In some examples, when a hosted browser tab 120 is displayed, a browser application 110 does not identify the hosted browser tab 120 as a current open tab unless a user performs an additional step of opening the hosted browser tab 120 in the browser (e.g., selecting a control that opens the hosted browser tab 120 in the browser). In some examples, a hosted browser tab 120 is allocated to the host application 106, where the hosted browser tab 120 can be used to display web content 118 within a user interface 114 of the host application 106. In some examples, a hosted browser tab 120 may be referred to as being embedded in the host application 106, running on top of the host application 106, being integrated in a user interface 114 of the host application 106, and so forth.

A host application 106 may be an application, executable by a user device 102, which initiates a request to display web content 118 based on user interaction with application content 144. The host application 106 is a non-browser application. A non-browser application may be an application that does not render one or more browser tabs in the context of a browser window. For example, the host application 106 is not a standalone web browser, a browser engine, or a search engine.

The host application 106 has a user interface 114 that is displayed on the user device 102. For example, in response to the host application 106 being launched, the host application 106 initiates display of its user interface 114. The user interface 114 includes application content 144. The application content 144 is information that is presented to the user on the display 112. The application content 144 may include text, image, video, UI elements, objects, controls, and/or menu items, etc. The user interface 114 may include one or a series of screens that enable the user to interact with the application content 144. The host application 106 may be a native application installable on an operating system 104 of the user device 102. In some examples, the host application 106 is a mobile application executing on a user device 102 with a smaller display 112 such as a smartphone, tablet, and/or wearable device (e.g., smartwatch, augmented reality (AR) device, virtual reality (VR) device). In some examples, the host application 106 is a web application executable by a browser application 110. In some examples, the host application 106 is a progressive web application.

The application content 144 includes a link 116 to web content 118. The link 116 may be selectable by the user, which, when selected, causes the display of web content 118 on the display 112. The web content 118 may be content that is stored on a server computer 152 and accessed over a network 150. The link 116 is associated with a resource locator 135 that identifies a location of the web content 118. In some examples, the resource locator 135 is a web address. In some examples, the resource locator is a uniform resource locator (URL). If the host application 106 is a social media application, the link 116 may be a link to web content 118 (e.g., a news article) included in a social media message. If the host application 106 is an email application, the link 116 may be a link to web content 118 (e.g., airline web page) included in an email message.

The host application 106 includes a web controller 105 configured to enable the host application 106 to incorporate web content 118 into the host application 106. The web controller 105, when included in the host application 106, is configured to enable the host application 106 to customize one or more parts of a hosted browser tab 120 that is used to display web content 118 within the host application 106. In some examples, the web controller 105 includes one or more application programming interfaces (API) that allows a developer to launch a hosted browser tab 120 or display web content 118 in the host application 106. In some examples, the web controller 105 includes a software development kit (SDK). In some examples, the web controller 105 is configured to communicate with a browser application 110 to render a hosted browser tab 120 with one or more customized attributes 126.

The host application 106 may define one or more customized attributes 126, which is used to customize a hosted browser tab 120 for displaying web content 118 initiated from the host application 106. For example, the web controller 105 may store one or more customized attributes 126 about a hosted browser tab 120. In some examples, the web controller 105 stores the customized attributes 126 in a computer object or class. An application developer may customize the hosted browser tab 120 by defining the customized attributes 126 in the computer object or class stored at the host application 106. The customized attributes 126 may customize one or more parts of a hosted browser tab 120. A customized attribute 126 may customize the appearance, features, and/or behavior of a hosted browser tab 120. The hosted browser tab 120 includes UI elements that are set (e.g., defined by) the browser application 110 such as browser menu items (e.g., new tab, downloads, bookmarks, find in page, translate, etc.) and/or a toolbar panel 128 with forward and/or back navigation controls, address field, etc.

When a browser tab 120a (e.g., a non-hosted browser tab or a non-custom browser tab) is launched directly from the browser application 110, the browser tab 120a has a color, appearance, features, and elements that are defined by the browser application 110. However, for a hosted browser tab 120, the developer of the host application 106 may modify or change one or more aspects of the hosted browser tab 120. For example, the browser application 110 may be an application distinct from the host application 106. The browser application 110 is launchable by the user, and the browser application 110 renders browser tabs 120a in the context of one or more windows. A user may use a browser tab 120a, generated by the browser application 110, to search and display web content. In some examples, the hosted browser tab 120 is different from the browser tab 120a in one or more aspects. In some examples, the hosted browser tab 120 cannot be used to search or display content other than the web content 118 selected from the application content 244.

In some examples, as shown in FIG. 1B, the customized attributes 126 may include one or more custom UI controls 164. A custom UI control 164 may be a UI element for an action executable by the host application 106. For example, if the host application 106 is a social media application, a custom UI control 164 may be a share button, which allows the user to share the web content 118 on the social media platform. In some examples, the customized attributes 126 may include a custom color 165 for one or more portions of the hosted browser tab 120 (e.g., a toolbar panel 128, and/or a menu color, etc.). In some examples, the customized attributes 126 include an animation effect 166 that is displayed when transitioning from the application content 144 to the web content 118. In some examples, the customized attributes 126 include a loading indicator 168 (e.g., a custom loading indicator) that is displayed when transitioning from the application content 144 to the web content 118.

In some examples, the customized attributes 126 include an attribute that enables the developer to display or hide a title 170 of the web content 118 in the hosted browser tab 120. In some examples, the customized attributes 126 may include a background 176 that is displayed as a background in one or more portions of the hosted browser tab 120. The background 176 may be a graphic, theme, image, or color. In some examples, the customized attributes 126 may include an attribute that enables or disables a reader mode 173 for the web content 118. A reader mode 173 is a feature that simplifies web content 118 by modifying and/or removing at least one of ads, images, UI elements, and/or objects. In some examples, the customized attributes 126 include a window size 172 for the hosted browser tab 120. The window size 172 may define a size of the hosted browser tab 120 when the hosted browser tab 120 is displayed on the display 112. For example, an application developer may set the window size 172 to a full screen size, which causes the size of the hosted browser tab 120 to correspond to the size of the display 112. However, the window size 172 may be a partial window size, which causes the size of the hosted browser tab 120 to occupy a portion of the display 112 (e.g., bottom portion or top portion of the display 112). In some examples, the default window size 172 is the full screen size. In some examples, the customized attributes 126 may define one or more aspects of a floating window 124 such as the size and/or shape and/or which information is displayed by the floating window 124.

In response to user selection to the link 116 in the application content 144, the web controller 105 generates and transmits a tab request 108 to the browser application 110. The tab request 108 includes the customized attribute(s) 126 and the resource locator 135 of the web content 118. In some examples, the web controller 105 transmits the tab request 108 to an API of the browser application 110. A tab request 108 may be an instruction to launch a hosted browser tab with web content 118 as indicated by the resource locator 135, and, in some examples, according to the customized attribute(s) 126. In some examples, the tab request 108 is an intent (e.g., a browser intent, or an intent request).

In some examples, in response to the tab request 108, the browser application 110 may retrieve the web content 118 using the resource locator 135 and generate the hosted browser tab 120 with the web content 118 and the customized attribute(s) 126. In some examples, the browser application 110 generates the hosted browser tab 120 in a background process. The browser application 110 may cause the hosted browser tab 120 to be displayed. In some examples, the hosted browser tab 120 is rendered within the context of a host application 106. For example, if a host application 106 incorporates the web controller 105, when a link 116 to web content 118 is selected, the web content 118 is rendered in a host browser tab 120 within the host application 106 (e.g., a separate browser tab is not rendered on top of the host app's user interface 114). In other words, the hosted browser tab 120 is integrated into the host application 106.

The browser application 110 initiates display of the hosted browser tab 120 with the customized attribute(s) 126 and the web content 118. As shown in FIG. 1C, the web content 118 may include UI element(s) 146 and data field(s) 148. A user may interact with the web content 118 by manipulating (e.g., selecting) the UI element(s) 146 and entering data (e.g., user-defined data) into the data field(s) 148.

While viewing and/or interacting with the web content 118, the user may minimize the hosted browser tab 120 by selecting a UI element or performing a gesture-based action. For example, the browser application 110 may detect a minimize event 111 based on user interaction with the hosted browser tab 120. The minimize event 111 may be an instruction to minimize the hosted browser tab 120. In some examples, in response to selection of a minimize icon 122, the browser application 110 may detect the minimize event 111. In some examples, in response to a toolbar panel 128 being dragged downward, the browser application 110 may detect the minimize event 111. The toolbar panel 128 may be a portion of the hosted browser tab 120 that includes one or more browser controls (e.g., address bar, menu items, or navigation controls).

In response to the minimize event 111, the browser application 110 stores the hosted browser tab 120 in a memory device 103 associated with the browser application 110. Storing the hosted browser tab 120 includes storing a page state 138 of the web content 118. In some examples, storing the hosted browser tab 120 includes storing the page state 138 of the web content 118 and a navigation stack 145 of previous web content opened in the hosted browser tab 120. The navigation stack may include information that identifies one or more web pages visited by the user using the hosted browser tab 120. A page state 138 of web content 118 may refer to a current state of the elements on the web content 118, which may include values of data field(s) 148, the states of UI elements 146 (e.g., buttons, checkboxes), and the visibility of the web content 118 (e.g., which portion of the web content 118 is currently viewed through a viewport). For example, while the hosted browser tab 120 is displayed, the user may interact with the web content 118 by selecting certain UI elements 146 and entering user data into the data field(s) 148. In response to the minimize event 111, the browser application 110 may store the page state 138 of the web content 118 in the memory device 103.

The navigation stack 145 may include information (e.g., resource locator(s)) about previous web content displayed in the hosted browser tab 120. The navigation stack 145 may be a list (e.g., an ordered list) of one or more web pages previously displayed in the hosted browser tab 120. For example, web page A may be initially displayed as the web content 118 in the hosted browser tab 120. A user may select content on web page A, which causes the hosted browser tab 120 to display web page B. Then the user may select content on web page B, which causes the hosted browser tab 120 to display web page C. When a minimize event 111 is detected with web page C displayed in the hosted browser tab 120, the navigation stack 145 includes web page A, web page B, and web page C with an indication that web page C is currently viewed. In some examples, the memory device 103 stores the page state 138 for the currently viewed web page (e.g., web page C). In some examples, the memory device 103 stores the page state 138 for any of the web pages in the navigation stack 145. In response to a restore event 113, the browser application 110 initiates display of the hosted browser tab 120 with web page C (e.g., the same webpage that was displayed when the minimize event 111 is detected). The user may use a back navigation control to navigate back to web page B, and may further navigate to web page A.

In response to the minimize event 111, the browser application 110 may hide the hosted browser tab 120 and initiate display of a floating window 124, where the floating window 124 includes information about the minimized hosted browser tab 120. In some examples, hiding the hosted browser tab 120 includes updating a display property 143 to hide the web content 118 (e.g., changing the value of the display property 143 from show to hide). The floating window 124 may remain in the foreground while the user can interact with the host application 106 and other applications on the user device 102. In some examples, the floating window 124 has a fixed size and/or shape, which is not re-sizable or reshapable. The floating window 124 may have a width that is less than the width of the display 112 and a height that is less than the height of the display 112. When the floating window 124 is displayed, in some examples, the application content 144 of the host application 106 is visible to the user. Further, the user may navigate to other interfaces of the user device 102, including launching other applications, and the floating window 124 may remain in the foreground.

In some examples, the floating window 124 has a rectangular shape. In some examples, the floating window 124 is movable to different parts of the display 112. For example, a user can drag the floating window 124 from one part of the display 112 to another part of the display 112. In some examples, the floating window 124 remains visibly displayed in the foreground despite any user interactions with other applications including the host application 106. The floating window 124 may display information about the minimized hosted browser tab 120. In some examples, the floating window 124 may display a title 170 of the web content 118. The title 170 may be a word or phrase that is defined in the metadata of the web content 118. In some examples, the floating window 124 may display the resource locator 135 (or a portion thereof) associated with the web content 118. In some examples, the floating window 124 may display an icon 174 of the web content 118. The icon 174 may be obtained from the metadata associated with the web content 118.

In some examples, the floating window 124 is an operating system feature of the operating system 104 of the user device 102. In some examples, the floating window 124 is a picture-in-picture (PIP) window. In some examples, the floating window 124 is a picture-in-picture window configured to display information about the minimized hosted browser tab 120. A PIP window is typically used for displaying video by a video player or a streaming service. In some examples, the floating window 124 is generated by modifying a PIP window to display static content. In some examples, in response to the minimize event 111, the browser application 110 may communicate with the operating system 104 to cause the operating system 104 to display the floating window 124.

The browser application 110 may transmit a window request 140 to a window manager 142 of the operating system 104. The window request 140 instructs the window manager 142 to create and display a floating window 124. The window request 140 includes information about the floating window 124 to be created. The window request 140 may include the title 170, the resource locator 135, and the icon 174 associated with the web content 118. In some examples, the window request 140 includes one or more configuration parameters that are used by the window manager 142 to generate the floating window 124. In some examples, the browser application 110 transmits the window request 140 to the window manager 142 via an API or IPC communication link. In response to the window request 140, the window manager 142 may generate and display the floating window 124 with the information included in the window request 140.

In some examples, the floating window 124 is a browser feature of the browser application 110. For example, in response to the minimize event 111, the browser application 110 may create and display the floating window 124 (e.g., without using the window manager 142).

In some examples, in response to the minimize event 111, the browser application 110 may transmit a callback 121 to the host application 106 (e.g., the web controller 105 of the host application 106). The callback 121 may include information about the hosted browser tab 120 and information that indicates that the hosted browser tab 120 has been minimized. In some examples, the callback 121 may include information about the floating window 124.

The user can restore the hosted browser tab 120 by interacting with the floating window 124. Interacting with the floating window 124 may include selecting (e.g., tapping, short pressing, etc.) the floating window 124, selecting a dedicated control on the floating window 124, or performing a user-based gesture with respect to the floating window 124. In response to an interaction with the floating window 124, the browser application 110 and/or the window manager 142 may detect a restore event 113. In response to the restore event 113, the browser application 110 and/or the window manager 142 may restore the hosted browser tab 120. Restoring the hosted browser tab 120 may include retrieving the hosted browser tab 120 from the memory device 103, re-displaying the hosted browser tab 120 on the display 112 according to the window size 172, and removing the floating window 124 from the display 112. Since the browser application 110 stores the page state 138 (e.g., the current page state) of the web content 118 when the minimize event 111 is detected, any user-provided selection and/or data is also restored when the hosted browser tab 120 is re-displayed. In addition, since the navigation stack 145 of the hosted browser tab 120 is stored in the memory device 103, the restored hosted browser tab 120 may enable a user to revisit prior web pages, which were viewed by the user before the hosted browser tab 120 was minimized.

In some examples, the window manager 142 detects a restore event 113 (e.g., when the floating window 124 is selected). A restore event 113 may be an instruction to restore the hosted browser tab 120. In response to the restore event 113, the window manager 142 terminates the floating window 124 and transmits a callback 125 to the browser application 110. The callback 125 may indicate that a restore event 113 has been detected. In some examples, the browser application 110 detects a restore event 113 (e.g., when the floating window 124 is selected). In some examples, the browser application 110 may terminate the floating window 124. In some examples, in response to the restore event 113, the browser application 110 may transmit a callback 125 to the window manager 142 that indicates that a restore event 113 has been detected, and the window manager 142 may terminate the floating window 124. In response to the callback 125 or the restore event 113, the browser application 110 may retrieve the hosted browser tab 120 from the memory device 103 and re-display the hosted browser tab 120. Re-displaying the hosted browser tab 120 may include updating (e.g., modifying) the display property 143 (e.g., changing the value of the display property 143 from hide to show). In response to the callback 125 or the restore event 113, the browser application 110 may transmit a callback 123 to the host application 106 (e.g., the web controller 105), where the callback 123 indicates that the hosted browser tab 120 has been restored.

A user may interact with the floating window 124 to delete the floating window 124, which causes the hosted browser tab 120 to be terminated and deleted from the memory device 103. In some examples, the floating window 124 includes one or more menu items 184 (e.g., UI elements) corresponding to one or more actions to be taken with respect to the floating window 124 (e.g., restore, delete, etc.). In some examples, in response to selection of a menu item 184, the floating window 124 and the hosted browser tab 120 are deleted. In some examples, in response to a long press selection on the floating window 124, the window manager 142 or the browser application 110 may display one or more menu items 184, and the user can select a particular action (e.g., restore, delete) by selecting a particular menu item 184. In some examples, in response to a long press selection, the window manager 142 may detect movement of the floating window 124 by the user to a location on the display 112 for deleting on-screen elements.

In some examples, the window manager 142 may detect a delete event 117 based on the user's interaction with the floating window 124. A delete event 117 may be an instruction to delete the floating window 124. In response to the delete event 117, the window manager 142 may generate and transmit a callback 127 to the browser application 110, where the callback 127 indicates that the floating window 124 is deleted. In response to the callback 127, the browser application 110 may delete the hosted browser tab 120 from the memory device 103. In some examples, the browser application 110 may generate and transmit a callback 129 to the host application 106, where the callback 129 indicates that the hosted browser tab 120 has been deleted. In some examples, the browser application 110 may detect a delete event 117 based on the user's interaction with the floating window 124. In response to the delete event 117, the browser application 110 may delete the hosted browser tab 120 from the memory device 103. In response to the delete event 117, the browser application 110 may generate and transmit a callback 127 to the window manager 142, where the callback 127 indicates detection of a delete event 117. In response to the callback 127, the window manager 142 may delete the floating window 124.

In some examples, the system 100 may enable the display of a single floating window 124 for one minimized hosted browser tab 120 at a particular time. For example, first web content from a first host application may be selected, which causes a display of a first hosted browser tab with the first web content. The first hosted browser tab may be minimized, which causes the display of a first floating window. In some examples, the system 100 requires that the first floating window be deleted (e.g., from a restore event 113 or a delete event 117) before the user can minimize a second hosted browser tab (e.g., initiated from the first host application or a second host application).

In some examples, the system 100 may enable multiple hosted browser tabs 120 to be minimized, stored, and later retrieved. For example, when the first hosted browser tab is minimized, the first floating window is displayed. While the first hosted browser tab is minimized, the user may navigate and select second web content from the first host application or from a second (different) host application, which causes the display of a second hosted browser tab with the first floating window remaining in the foreground. The second hosted browser tab may be minimized, which causes the display of a second floating window. The first floating window and the second floating window may be simultaneously displayed on the display 112 at different locations. In some examples, the first and second floating windows are independently moveable (e.g., can be separately moved to different parts of the display 112). In some examples, the first and second floating windows are displayed adjacent to each other.

In some examples, in response to a number of minimized active hosted browser tabs 120 achieving a threshold level (e.g., two, three, four, five, or any number greater than five), the window manager 142 or the browser application 110 may display a single floating window with information that indicates that multiple minimized hosted browser tabs are active (e.g., opened). In some examples, in response to selection of the single floating window (e.g., user taps or presses on the single floating window), the window manager 142 or the browser application 110 may render a UI object with a list of the active minimized hosted browser tabs 120, where a selection to one of the active minimized hosted browser tabs 120 causes that minimized hosted browser tab 120 to be restored.

In some examples, the browser application 110 may limit the number of active minimized hosted browser tabs and/or causes an active minimized custom tab to terminate after a threshold period of time (e.g., terminates after five minutes) to reduce the memory usage of the user device 102, which can improve performance. In some examples, the browser application 110 detects whether a time from when a minimize event 111 exceeds a threshold level (e.g., two minutes, five minutes, ten minutes, etc.), and, if so, deletes (without user prompting) the hosted browser tab 120 from the memory device 103 and initiates removal of the floating window 124. In some examples, the browser application 110 detects whether the number of minimized active hosted browser tabs 120 is equal to or greater than a threshold level, and, if so, disables a subsequent attempt to minimize a hosted browser tab 120. In other words, if the number of minimized active hosted browser tabs 120 is equal to or greater than the threshold level, the user is prevented from minimizing another hosted browser tab 120.

A browser application 110 is a web browser configured to access information on the Internet. The browser application 110 may launch one or more browser tabs 120a in the context of one or more browser windows on a display 112 of the user device 102. A browser tab 120a or a hosted browser tab 120 may display content (e.g., web content) associated with a web document (e.g., webpage. PDF, images, videos, etc.) and/or an application such as a web application, progressive web application (PWA), and/or extension. A web application may be an application program that is stored on a remote server (e.g., a web server) and delivered over the network through the browser application 110 (e.g., a browser tab). In some examples, a progressive web application is similar to a web application but can also be stored (at least in part) on the user device 102 and used offline. An extension adds a feature or function to the browser application 110. In some examples, an extension may be HTML, CSS, and/or JavaScript based (for browser-based extensions).

The user device 102 may be any type of computing device that includes one or more processors 101, one or more memory devices 103, a display 112, and an operating system 104 configured to execute (or assist with executing) one or more applications, including a host application 106 and a browser application 110. In some examples, the user device 102 is a smartphone or a tablet. In some examples, the user device 102 is a laptop computer or a desktop computer. In some examples, the user device 102 is a wearable device such as a smartwatch or a head-mounted display device such as an AR device or a VR device. In some examples, the user device 102 is a television device.

The operating system 104 is a system software that manages computer hardware, software resources, and provides common services for the applications. In some examples, the operating system 104 is an operating system for a smaller display 112 such as a tablet or a smartphone (e.g., sometimes referred to as a mobile operating system). In some examples, the operating system 104 is an operating system designed for a larger display 112 such as a laptop or desktop (e.g., sometimes referred to as a desktop operating system). The operating system 104 includes a window manager 142, which may be a sub-component of the operating system 104. In some examples, the functionalities of the window manager 142 are included in the browser application 110.

The processor(s) 101 may be formed in a substrate configured to execute one or more machine executable instructions or pieces of software, firmware, or a combination thereof. The processor(s) 101 can be semiconductor-based—that is, the processors can include semiconductor material that can perform digital logic. The memory device(s) 103 may include a main memory that stores information in a format that can be read and/or executed by the processor(s) 101. The memory device(s) 103 may store the operating system 104 (including the window manager 142), the host application 106, and the browser application 110 that, when executed by the processors 101, perform certain operations discussed herein. In some examples, the memory device(s) 103 includes a non-transitory computer-readable medium that includes executable instructions that cause at least one processor (e.g., the processors 101) to execute the operations discussed herein.

The server computer(s) 152 may be computing devices that take the form of a number of different devices, for example a standard server, a group of such servers, or a rack server system. In some examples, the server computer(s) 152 may be a single system sharing components such as processors and memories. In some examples, the server computer(s) 152 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within network 150. Network 150 may further include any number of hardwired and/or wireless connections.

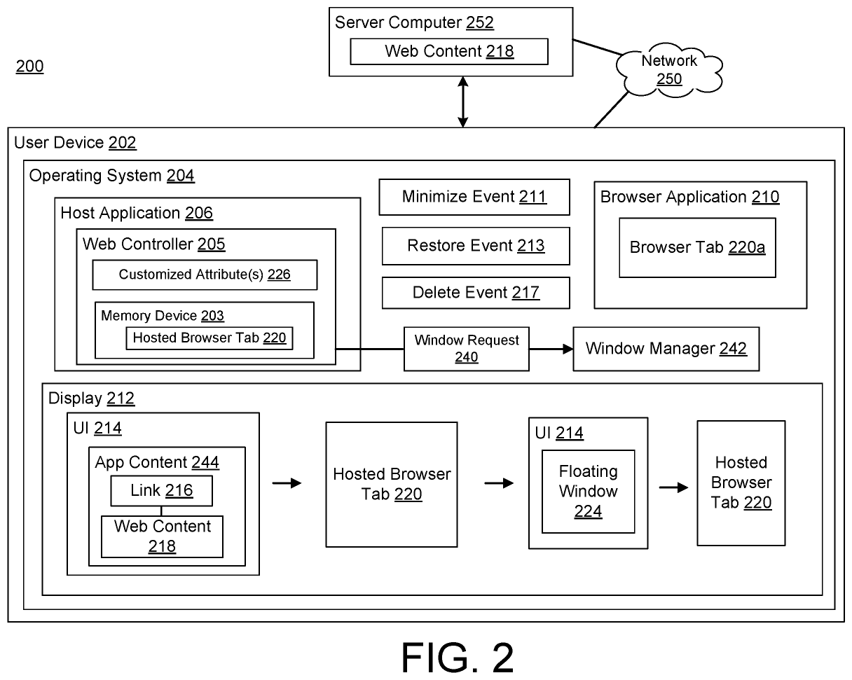

FIG. 2 illustrates a system 200 that enables switching from web content 218 in a hosted browser tab 120 to application content 244 in a host application 106 in a manner that preserves a page state (e.g., the page state 138 of FIGS. 1A to 1D) of the web content 218 and/or a navigation stack (e.g., the navigation stack 145 of FIGS. 1A to 1D) of previous web content rendered in the hosted browser tab 120. The system 200 of FIG. 2 may be an example of the system 100 of FIGS. 1A to 1D and may include any of the details discussed with reference to those figures. The system 200 includes a user device 202 with an operating system 204 that executes a host application 206. The user device 202 may (or may not) include a browser application 210. The host application 206 includes a web controller 205. However, in the system 200 of FIG. 2, the web controller 205 generates and displays a hosted browser tab 220. For example, in response to selection of a link 216 to web content 218 from application content 244 displayed in a user interface 214 of the host application 206, the web controller 205 may generate and display a hosted browser tab 220 with the web content 218.

A hosted browser tab 220 may be a graphical user interface that displays web content 218. A hosted browser tab 220 may be referred to as a browser window, a window that displays web content, a web interface, or a web window. A hosted browser tab 220 may include one or more UI elements associated with the web content 218 such as an address bar (e.g., displaying a resource locator) and/or a navigation control (e.g., a back button). The hosted browser tab 220 may refer to the web window generated by the web controller 205. In some examples, the hosted browser tab 220 is similar (the same) as a browser tab 220a generated by a browser application 210. The browser application 210 may be an application distinct from the host application 206. The browser application 210 is launchable by the user, and the browser application 210 renders browser tabs 220a in the context of one or more windows. A user may use a browser tab 220a, generated by the browser application 210, to search and display web content. In some examples, the hosted browser tab 220 is different from the browser tab 220a in one or more aspects. In some examples, the hosted browser tab 220 cannot be used to search or display content other than the web content 218 selected from the application content 244.

In some examples, the hosted browser tab 220 is a web interface customized by the host application 206. In some examples, the hosted browser tab 220 is referred to as a custom browser tab. A custom browser tab is a hosted browser tab 220 with one or more customized attributes 226 defined by a host application 206. In some examples, a custom browser tab is displayed when a link 216 to web content 218 is selected in the host application 206. In some examples, the hosted browser tab 220 is terminated when an instruction to navigate back to the host application 206 is detected (e.g., the user selects a back navigation control).

A host application 206 may be an application, executable by a user device 202, which initiates a request to display web content 218 based on user interaction with application content 244. The host application 206 is a non-browser application (e.g., an application that does not render browser tabs). For example, the host application 206 is not a web browser, a browser engine, or a search engine. However, when the host application 206 includes the web controller 205, the web controller 205 may retrieve web content 218 associated with the selected link 216 and display the web content 218 in a hosted browser tab 220.

The host application 206 has a user interface 214 that is displayed on the user device 202. For example, in response to the host application 206 being launched, the host application 206 initiates display of its user interface 214. The user interface 214 includes application content 244. The application content 244 is information that is presented to the user on the display 212. The application content 244 may include text, image, video, UI elements, objects, controls, and/or menu items, etc. The user interface 214 may include one or a series of screens that enable the user to interact with the application content 244. The host application 206 may be a native application installable on an operating system 204 of the user device 202. In some examples, the host application 206 is a mobile application executing on a user device 202 with a smaller display 212 such as a smartphone, tablet, and/or wearable device (e.g., smartwatch, augmented reality (AR) device, virtual reality (VR) device).

The application content 244 includes a link 216 to web content 218. The link 216 may be selectable by the user, which, when selected, causes the display of web content 218 on the display 212. The web content 218 may be content that is stored on a server computer 252 and accessed over a network 250. The link 216 is associated with a resource locator (e.g., the resource locator 135) that identifies a location of the web content 218. In some examples, the resource locator is a web address. In some examples, the resource locator is a uniform resource locator (URL). If the host application 206 is a social media application, the link 216 may be a link to web content 218 (e.g., a news article) included in a social media message. If the host application 206 is an email application, the link 216 may be a link to web content 218 (e.g., airline web page) included in an email message.

The web controller 205 is configured to enable the host application 206 to incorporate web content 218 into the host application 206. The web controller 205, when included in the host application 206, enables the host application 206 to display web content 218. The web controller 205 may include a retrieval engine configured to retrieve the web content 218 from the server computer 252. In some examples, the web controller 205 is configured to communicate with a window manager 242 via an API or an IPC link. In some examples, the web controller 205 includes a software development kit (SDK). In some examples, the web controller 205 is software that is owned or managed by an entity that owns or manages the browser application 210.

In some examples, the web controller 205 does not store customized attributes 226, where the hosted browser tab 220 is similar in appearance and/or functionality to a browser tab 220a generated by the browser application 210. In some examples, the web controller 205 stores one or more customized attributes 226 about a hosted browser tab 220. In some examples, the web controller 205 stores the customized attributes 226 in a computer object or class. An application developer may customize the hosted browser tab 220 by defining the customized attributes 226 in the computer object or class stored at the host application 206. The customized attributes 226 may customize one or more parts of a hosted browser tab 220.

A customized attribute 226 may customize the appearance, features, and/or behavior of a hosted browser tab 220. The hosted browser tab 220 includes UI elements that are set (e.g., defined by) the browser application 210 such as browser menu items (e.g., new tab, downloads, bookmarks, find in page, translate, etc.) and/or a navigation panel with forward and/or back navigation controls, address field, etc. When a browser tab 220a is launched directly from the browser application 210 (e.g., a non-hosted browser tab or a non-custom browser tab), the non-custom browser tab (e.g., browser tab 220a) has a color, appearance, features, and elements that are defined by the browser application 210. However, for a hosted browser tab 220, the developer of the host application 206 may modify or change one or more aspects of the hosted browser tab 220. The customized attributes 226 may be any of the customized attributes 126 described with reference to FIGS. 1A to 1D.

In response to user selection to the link 216 in the application content 244, the web controller 205 retrieves the web content 218 using the resource locator and generates and displays a hosted browser tab 220 with the web content 218. In some examples, the hosted browser tab 220 is configured according to the customized attribute(s) 226 stored at the web controller 205. In some examples, the web controller 205 generates the hosted browser tab 220 in a background process.

While viewing and/or interacting with the web content 218, the user may minimize the hosted browser tab 220 by selecting a UI element or performing a gesture-based action. For example, the web controller 205 may detect a minimize event 211 based on user interaction with the hosted browser tab 220. In some examples, in response to selection of a minimize icon (e.g., the minimize icon 122 of FIG. 1C), the web controller 205 may detect the minimize event 211. In some examples, in response to a toolbar panel (e.g., toolbar panel 128 of FIG. 1C) being dragged downward, the web controller 205 may detect the minimize event 211. The toolbar panel may be a portion of the hosted browser tab 220 that includes one or more browser controls (e.g., address bar, menu items, or navigation controls).

In response to the minimize event 211, the web controller 205 stores the hosted browser tab 220 in a memory device 203. Storing the hosted browser tab 220 includes storing a page state (e.g., the page state 138 of FIGS. 1A to 1D) of the web content 218. In some examples, storing the hosted browser tab 220 includes storing the page state and a navigation stack (e.g., the navigation stack 145 of FIGS. 1A to 1D). A page state of web content 218 may refer to a current state of the elements on the web content 218, which may include values of data field(s) (e.g., the data fields 148 of FIGS. 1A to 1D), the states of UI elements (e.g., the UI elements 146 of FIGS. 1A to 1D) (e.g., buttons, checkboxes), and the visibility of the web content 118 (e.g., which portion of the web content 218 is currently viewed through a viewport). For example, while the hosted browser tab 220 is displayed, the user may interact with the web content 218 by selecting certain UI elements and entering user data into the data field(s). In response to the minimize event 211, the web controller 205 may store the page state of the web content 218 in the memory device 203. In addition, since the navigation stack of the hosted browser tab 220 is stored in the memory device 203, the restored hosted browser tab 220 may enable a user to revisit prior web pages, which were viewed by the user before the hosted browser tab 220 was minimized. The navigation stack may include information (e.g., resource locator(s)) about previous web content displayed in the hosted browser tab 220. The navigation stack may be one or more web pages previously displayed in the hosted browser tab 220.

In response to the minimize event 211, the web controller 205 may hide the hosted browser tab 220 and initiate display of a floating window 224, where the floating window 224 includes information about the minimized hosted browser tab 220. In some examples, hiding the hosted browser tab 220 includes updating a value of a display property (e.g., the display property 143 of FIGS. 1A to 1D) to hide the web content 218. The floating window 224 may remain in the foreground while the user can interact with the host application 206 and other applications on the user device 202. The floating window 224 may include any of the details as discussed with reference to the floating window 124 of FIGS. 1A to 1D.

In some examples, the floating window 224 is an operating system feature of the operating system 204 of the user device 202. In some examples, the floating window 224 is a picture-in-picture (PIP) window. In some examples, the floating window 224 is a picture-in-picture window configured to display information about the minimized hosted browser tab 220. In some examples, in response to the minimize event 211, the web controller 205 may communicate with the operating system 204 to cause the operating system 204 to display the floating window 224.

The web controller 205 may transmit a window request 240 to a window manager 242 of the operating system 204. The window request 240 instructs the window manager 242 to create and display a floating window 224. The window request 240 includes information about the floating window 224 to be created. The window request 240 may include a title (e.g., the title 170 of FIGS. 1A to 1D), a resource locator (e.g., the resource locator 135 of FIGS. 1A to 1D), and an icon (e.g., the icon 174 of FIGS. 1A to 1D) associated with the web content 218. In some examples, the window request 240 includes one or more configuration parameters that are used by the window manager 242 to generate the floating window 224. In some examples, the web controller 205 transmits the window request 240 to the window manager 242 via an API or IPC communication link. In response to the window request 240, the window manager 242 may generate and display the floating window 224 with the information included in the window request 240. In some examples, the floating window 224 is a feature of the web controller 205. For example, in response to the minimize event 211, the web controller 205 may create and display the floating window 224 (e.g., without using the window manager 242).

The user can restore the hosted browser tab 220 by interacting with the floating window 224. Interacting with the floating window 224 may include selecting (e.g., tapping, short pressing, etc.) the floating window 224, selecting a dedicated control on the floating window 224, or performing a user-based gesture with respect to the floating window 224. In response to an interaction with the floating window 224, the web controller 205 and/or the window manager 242 may detect a restore event 213. In response to the restore event 213, the web controller 205 and/or the window manager 242 may restore the hosted browser tab 220. Restoring the hosted browser tab 220 may include retrieving the hosted browser tab 220 from the memory device 203, re-displaying the hosted browser tab 220 on the display 212, and removing the floating window 224 from the display 212. Since the web controller 205 stores the page state (e.g., the current page state) of the web content 218 when the minimize event 211 is detected, any user-provided selection and/or data is also restored when the hosted browser tab 220 is re-displayed.

In some examples, the window manager 242 detects a restore event 213 (e.g., when the floating window 224 is selected). In response to the restore event 213, the window manager 242 terminates the floating window 224 and transmits a callback to the web controller 205. The callback may indicate that a restore event 213 has been detected. In some examples, the web controller 205 detects a restore event 213 (e.g., when the floating window 224 is selected). In some examples, the web controller 205 may terminate the floating window 224. In some examples, in response to the restore event 213, the web controller 205 may transmit a callback to the window manager 242 that indicates that a restore event 213 has been detected, and the window manager 242 may terminate the floating window 224. Then, the web controller 205 retrieves the hosted browser tab 220 from the memory device 203 and re-displays the hosted browser tab 220. Re-displaying the hosted browser tab 220 may include updating (e.g., modifying) a display property (e.g., the display property 143 of FIGS. 1A to 1D) (e.g., changing the value of the display property from hide to show).

A user may interact with the floating window 224 to delete the floating window 224, which causes the hosted browser tab 220 to be terminated and deleted from the memory device 203. In some examples, the floating window 224 includes one or more menu items (e.g., menu items 184 of FIGS. 1A to 1D) (e.g., UI elements) corresponding to one or more actions to be taken with respect to the floating window 224 (e.g., restore, delete, etc.). In some examples, in response to selection of a menu item, the floating window 224 and the hosted browser tab 220 are deleted. In some examples, in response to a long press selection on the floating window 224, the window manager 242 or the web controller 205 may display one or more menu items, and the user can select a particular action (e.g., restore, delete) by selecting a particular menu item. In some examples, in response to a long press selection, the window manager 242 may detect movement of the floating window 224 by the user to a location on the display 212 for deleting on-screen elements.

In some examples, the window manager 242 may detect a delete event 217 based on the user's interaction with the floating window 224. In response to the delete event 217, the window manager 242 may generate and transmit a callback to the web controller 205, where the callback indicates that the floating window 224 is deleted. In response to the callback, the web controller 205 may delete the hosted browser tab 220 from the memory device 203. In some examples, the web controller 205 may detect a delete event 217 based on the user's interaction with the floating window 224. In response to the delete event 217, the web controller 205 may delete the hosted browser tab 220 from the memory device 203. In response to the delete event 217, the web controller 205 may generate and transmit a callback to the window manager 242, where the callback indicates detection of a delete event 217. In response to the callback, the window manager 242 may delete the floating window 224.

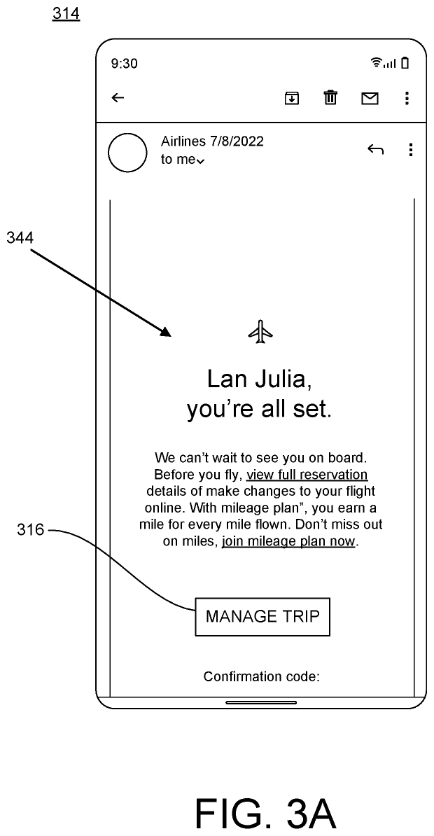

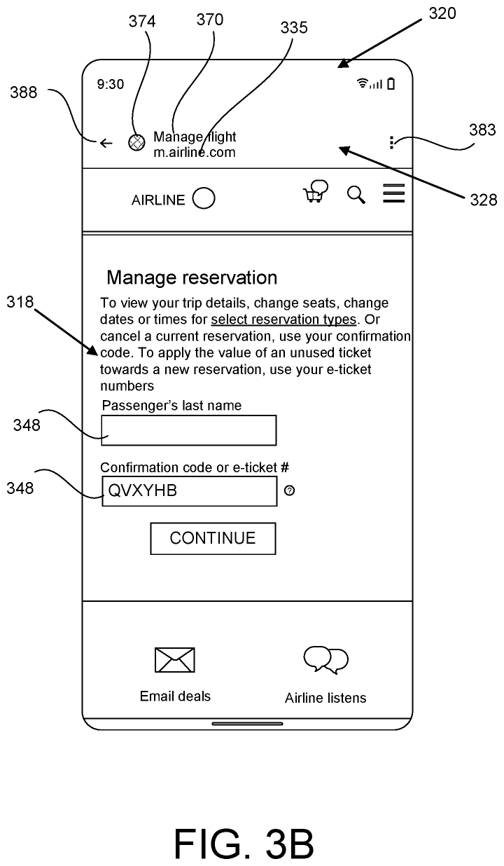

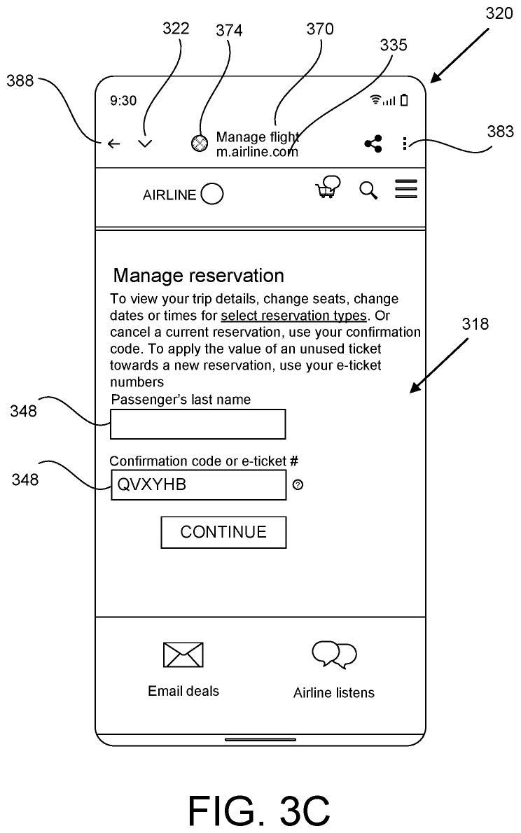

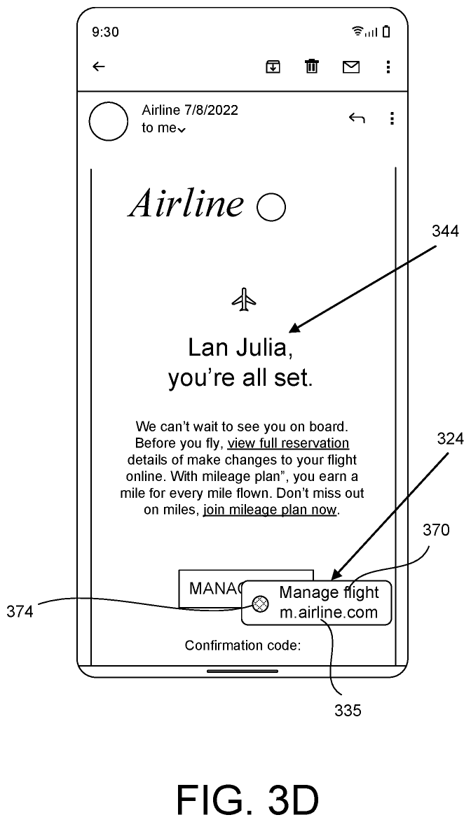

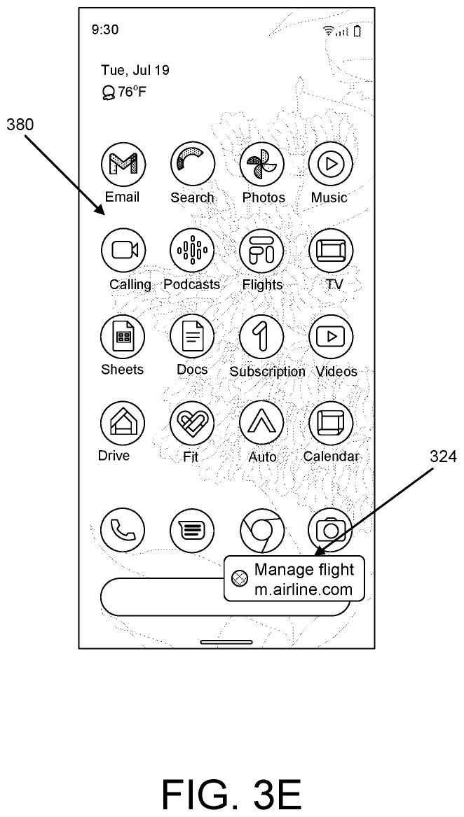

FIGS. 3A to 3E illustrate various user interfaces for switching between application content 344 and web content 318 in a manner that preserves the page state of web content 318 and/or the navigation stack of previous web content displayed in a hosted browser tab 320. The user interfaces of FIGS. 3A to 3E are examples of user interfaces generated by the system 100 of FIGS. 1A to 1D and/or the system 200 of FIG. 2 and may include any of the details discussed with reference to those figures. FIG. 3A illustrates a user interface 314 of a host application. The user interface 314 displays application content 344 with a link 316 to web content 318. In the example of FIGS. 3A to 3E, the host application is an email application, which displays a portion of an email with a link to web content 318.

The user can select the link 316 (e.g., the content “manage trip” associated with a resource locator 335 of an airline's webpage), which initiates display of a hosted browser tab 320, as shown in FIG. 3B. In some examples, the browser application 110 of FIGS. 1A to 1D generates and displays the hosted browser tab 320. In some examples, the web controller 205 of FIG. 2 generates and displays the hosted browser tab 320. In some examples, the hosted browser tab 320 is customized according to one or more customized attributes (e.g., customized attributes 126 of FIGS. 1A to 1D or customized attributes 226 of FIG. 2). The hosted browser tab 320 includes the web content 318. The hosted browser tab 320 includes a toolbar 328 with a back navigation control 388, an icon 374 of the web content 318, a title 370 of the web content 318, a resource locator 335 of the web content 318, and a menu icon 383. The menu icon 383, when selected, may initiate a display of menu items for actions to be taken with respect to the web content 318 and/or actions to be taken with respect to the host application.

The web content 318 includes data fields 348 for receiving user-input. As shown in FIG. 3B, the user has started to enter data in one of the data fields 348. In some examples, when the user selects the back navigation control 388, the user interface 314 of FIG. 3A is re-displayed, but any content that was entered in the data fields 348 is discarded. However, according to the techniques discussed herein, the user may drag the toolbar 328 in a downward manner, which causes the display of a floating window 324, as shown in FIG. 3D. In some examples, as shown in FIG. 3C, the hosted browser tab 320 may include a minimize icon 322, which, when selected, causes the display of a floating window 324, as shown in FIG. 3D.

As shown in FIG. 3D, the hosted browser tab 320 is hidden, thereby displaying the underlying content, e.g., the application content 344 of the host application. The floating window 324 is displayed in the foreground, and the user can interact with the application content 344 (and other applications on the user device). The floating window 324 includes the title 370 of the web content 318, the icon 374 of the web content 318, and the resource locator 335 of the web content 318.

As shown in FIG. 3E, the user may navigate to a home screen 380 of the user device, which displays various application icons. However, the floating window 324 remains in the foreground. The user may select the floating window 324, which causes the hosted browser tab 320 to be restored. For example, in response to selection of the floating window 324, the hosted browser tab 320 of FIG. 3B or 3C may be re-displayed along with any information that was entered by the user.

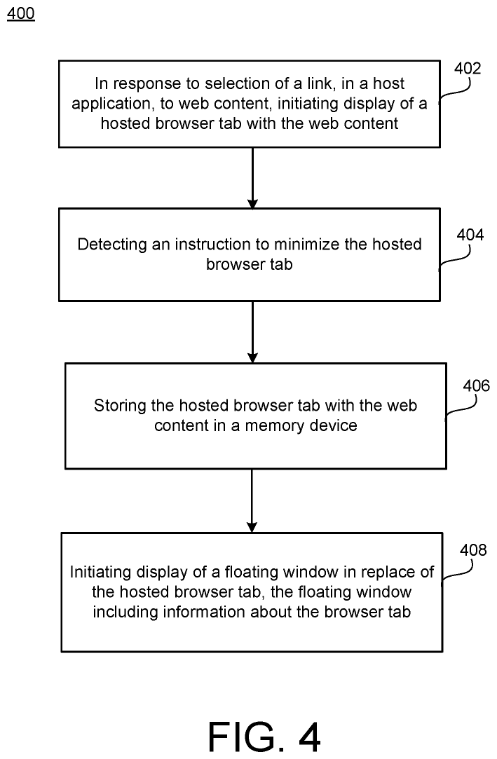

FIG. 4 is a flowchart 400 depicting example operations of switching from web content in a hosted browser tab to application content of a host application in a manner that preserves a page state and/or a navigation stack of previous web content in the hosted browser tab. Although the flowchart 400 is explained with respect to the system 100 of FIGS. 1A to 1D, the flowchart 400 may be applicable to any of the implementations discussed herein. Although the flowchart 400 of FIG. 4 illustrates the operations in sequential order, it will be appreciated that this is merely an example, and that additional or alternative operations may be included. Further, operations of FIG. 4 and related operations may be executed in a different order than that shown, or in a parallel or overlapping fashion.

Operation 402 includes, in response to selection, in a host application 106, of a link 116 to web content 118, initiating display of a hosted browser tab 120 with the web content 118. Operation 404 includes detecting an instruction to minimize the hosted browser tab 120. Operation 406 includes storing the hosted browser tab 120 with the web content 118 in a memory device 103. Operation 408 includes initiating display of a floating window 124 in replace of the hosted browser tab 120, the floating window 124 including information about the hosted browser tab 120.

Clause 1. A non-transitory computer-readable medium storing executable instructions that when executed by at least one processor cause the at least one processor to execute operations, the operations comprising: in response to selection, in a host application, of a link to web content, initiating display of a hosted browser tab with the web content; and in response to detecting an instruction to minimize the hosted browser tab: storing the hosted browser tab with the web content in a memory device; and initiating display of a floating window instead of the hosted browser tab, the floating window including information about the hosted browser tab.

Clause 2. The non-transitory computer-readable medium of clause 1, wherein the operations further comprise: obtaining at least one customized attribute about the hosted browser tab; and generating the hosted browser tab according to the at least one customized attribute.

Clause 3. The non-transitory computer-readable medium of clause 2, wherein the operations further comprise: in response to the selection of the link in the host application, receiving a tab request from the host application, the tab request including a location of the web content and the at least one customized attribute; and in response to the tab request, generating the hosted browser tab.

Clause 4. The non-transitory computer-readable medium of any one of clauses 1 to 3, wherein the floating window includes a picture-in-picture (PIP) window.

Clause 5. The non-transitory computer-readable medium of any one of clauses 1 to 4, wherein the operations further comprise: in response to detecting the instruction to minimize the hosted browser tab, transmitting a window request to a window manager, the window request being an instruction to generate and display the floating window, the window request including the information about the hosted browser tab.

Clause 6. The non-transitory computer-readable medium of any one of clauses 1 to 5, wherein the information about the hosted browser tab includes at least one of a title of the web content, an icon associated with the web content, and a resource locator of the web content.

Clause 7. The non-transitory computer-readable medium of any one of clauses 1 to 6, wherein the operations further comprise: in response to detecting the instruction to minimize the hosted browser tab, updating a value of a display property to hide the hosted browser tab.

Clause 8. The non-transitory computer-readable medium of any one of clauses 1 to 7, further comprising: in response to detecting an instruction to delete the floating window: initiating removal of the floating window; and deleting the hosted browser tab from the memory device.

Clause 9. The non-transitory computer-readable medium of any one of clauses 1 to 8, further comprising: in response to detecting an instruction to restore the hosted browser tab: initiating removal of the floating window; and re-displaying the hosted browser tab.

Clause 10. An apparatus comprising: at least one processor; and a non-transitory computer-readable medium storing executable instructions that cause the at least one processor to execute: in response to selection, in a host application, of a link to web content, initiate display of a hosted browser tab according to at least one customized attribute, the hosted browser tab including the web content; and in response to detection of an instruction to minimize the hosted browser tab: store the hosted browser tab with the web content in a memory device; and initiate display of a floating window instead of the hosted browser tab, the floating window including information about the hosted browser tab.

Clause 11. The apparatus of clause 10, wherein the at least one customized attribute includes a custom user interface control for an action executable by the host application.

Clause 12. The apparatus of clause 10 or 11, wherein the executable instructions include instructions that cause the at least one processor to: in response to the selection of the link to the web content, receive a tab request from the host application, the tab request including a location of the web content and the at least one customized attribute; and in response to the tab request, generate the hosted browser tab.

Clause 13. The apparatus of any one of clauses 10 to 12, wherein the executable instructions include instructions that cause the at least one processor to: in response to detecting the instruction to minimize the hosted browser tab: update a value of a display property to hide the hosted browser tab; and transmit a window request to a window manager, the window request being an instruction to generate and display the floating window, the window request including the information about the hosted browser tab.

Clause 14. The apparatus of any one of clauses 10 to 13, wherein the executable instructions include instructions that cause the at least one processor to: in response to detecting an instruction to delete the floating window: initiate removal of the floating window; and delete the hosted browser tab from the memory device.

Clause 15. The apparatus of any one of clauses 10 to 14, wherein the executable instructions include instructions that cause the at least one processor to: in response to detecting an instruction to restore the hosted browser tab: initiate removal of the floating window; and re-display the hosted browser tab.

Clause 16. A method comprising: in response to selection, in a host application, of a link to web content, initiating display of a hosted browser tab with the web content; and in response to detecting an instruction to minimize the hosted browser tab: storing the hosted browser tab with the web content in a memory device; and initiating display of a floating window instead of the hosted browser tab, the floating window including information about the hosted browser tab.

Clause 17. The method of clause 16, further comprising: obtaining at least one customized attribute about the hosted browser tab; and generating the hosted browser tab according to the at least one customized attribute.

Clause 18. The method of clause 17, further comprising: in response to the selection of the link to the web content, receiving a tab request from the host application, the tab request including a location of the web content and the at least one customized attribute; and in response to the tab request, generating the hosted browser tab.

Clause 19. The method of any one of clauses 16 to 18, further comprising: in response to detecting the instruction to minimize the hosted browser tab, transmitting a window request to a window manager, the window request being an instruction to generate and display the floating window, the window request including the information about the hosted browser tab.

Clause 20. The method of any one of clauses 16 to 19, further comprising: in response to detecting the instruction to minimize the hosted browser tab: updating a display property to hide the hosted browser tab; and transmitting a window request to a window manager, the window request being an instruction to generate and display the floating window, the window request including the information about the hosted browser tab.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A non-transitory computer-readable medium storing executable instructions that when executed by at least one processor cause the at least one processor to execute operations, the operations comprising:
in response to selection, in a host application, of a link to web content, initiating display of a hosted browser tab with the web content; and
in response to detecting an instruction to minimize the hosted browser tab:
storing the hosted browser tab with the web content in a memory device; and
initiating display of a floating window instead of the hosted browser tab, the floating window including information about the hosted browser tab.

2. The non-transitory computer-readable medium of claim 1, wherein the operations further comprise:
obtaining at least one customized attribute about the hosted browser tab; and
generating the hosted browser tab according to the at least one customized attribute.

3. The non-transitory computer-readable medium of claim 2, wherein the operations further comprise:
in response to the selection of the link in the host application, receiving a tab request from the host application, the tab request including a location of the web content and the at least one customized attribute; and
in response to the tab request, generating the hosted browser tab.

4. The non-transitory computer-readable medium of claim 1, wherein the floating window includes a picture-in-picture (PIP) window.

5. The non-transitory computer-readable medium of claim 1, wherein the operations further comprise:
in response to detecting the instruction to minimize the hosted browser tab, transmitting a window request to a window manager, the window request being an instruction to generate and display the floating window, the window request including the information about the hosted browser tab.

6. The non-transitory computer-readable medium of claim 1, wherein the information about the hosted browser tab includes at least one of a title of the web content, an icon associated with the web content, and a resource locator of the web content.

7. The non-transitory computer-readable medium of claim 1, wherein the operations further comprise:
in response to detecting the instruction to minimize the hosted browser tab, updating a value of a display property to hide the hosted browser tab.

8. The non-transitory computer-readable medium of claim 1, further comprising:
in response to detecting an instruction to delete the floating window:
initiating removal of the floating window; and
deleting the hosted browser tab from the memory device.

9. The non-transitory computer-readable medium of claim 1, further comprising:
in response to detecting an instruction to restore the hosted browser tab:
initiating removal of the floating window; and
re-displaying the hosted browser tab.

10. An apparatus comprising:
at least one processor; and
a non-transitory computer-readable medium storing executable instructions that cause the at least one processor to execute:
in response to selection, in a host application, of a link to web content, initiate display of a hosted browser tab according to at least one customized attribute, the hosted browser tab including the web content; and
in response to detection of an instruction to minimize the hosted browser tab:
store the hosted browser tab with the web content in a memory device; and
initiate display of a floating window instead of the hosted browser tab, the floating window including information about the hosted browser tab.

11. The apparatus of claim 10, wherein the at least one customized attribute includes a custom user interface control for an action executable by the host application.

12. The apparatus of claim 10, wherein the executable instructions include instructions that cause the at least one processor to:
in response to the selection of the link to the web content, receive a tab request from the host application, the tab request including a location of the web content and the at least one customized attribute; and
in response to the tab request, generate the hosted browser tab.

13. The apparatus of claim 10, wherein the executable instructions include instructions that cause the at least one processor to:
in response to detecting the instruction to minimize the hosted browser tab:
update a value of a display property to hide the hosted browser tab; and
transmit a window request to a window manager, the window request being an instruction to generate and display the floating window, the window request including the information about the hosted browser tab.

14. The apparatus of claim 10, wherein the executable instructions include instructions that cause the at least one processor to:
in response to detecting an instruction to delete the floating window:
initiate removal of the floating window; and
delete the hosted browser tab from the memory device.

15. The apparatus of claim 10, wherein the executable instructions include instructions that cause the at least one processor to:
in response to detecting an instruction to restore the hosted browser tab:
initiate removal of the floating window; and
re-display the hosted browser tab.

16. A method comprising:
in response to selection, in a host application, of a link to web content, initiating display of a hosted browser tab with the web content; and
in response to detecting an instruction to minimize the hosted browser tab:
storing the hosted browser tab with the web content in a memory device; and
initiating display of a floating window in replace of the hosted browser tab, the floating window including information about the hosted browser tab.

17. The method of claim 16, further comprising:
obtaining at least one customized attribute about the hosted browser tab; and
generating the hosted browser tab according to the at least one customized attribute.

18. The method of claim 17, further comprising:
in response to the selection of the link to the web content, receiving a tab request from the host application, the tab request including a location of the web content and the at least one customized attribute; and
in response to the tab request, generating the hosted browser tab.

19. The method of claim 16, further comprising:
in response to detecting the instruction to minimize the hosted browser tab, transmitting a window request to a window manager, the window request being an instruction to generate and display the floating window, the window request including the information about the hosted browser tab.

20. The method of claim 16, further comprising:
in response to detecting the instruction to minimize the hosted browser tab:
updating a display property to hide the hosted browser tab; and
transmitting a window request to a window manager, the window request being an instruction to generate and display the floating window, the window request including the information about the hosted browser tab.
